(19) United States
(12) Patent Application Publication
(10) Pub. No.: US 2022/0039445 A1
(43) Pub. Date: Feb. 10, 2022

(54) Greek Style Salad Dressing and Method of Preparing

(71) Applicant: Alex Dimitriadis, Assonet, MA (US)

(72) Inventor: Alex Dimitriadis, Assonet, MA (US)

(21) Appl. No.: 17/396,659

(22) Filed: Aug. 7, 2021

Related U.S. Application Data
(60) Provisional application No. 63/063,253, filed on Aug. 8, 2020.

(51) Int. Cl. A23L 27/60

(52) U.S. Cl. CPC A23L 27/60; A23V 2002/00

(57) ABSTRACT

A Greek salad dressing is provided using a combination of ingredients which includes feta cheese, onions, vinegar, sugar, oil, feta juice brine, garlic, black pepper, parsley, oregano, and basil. The feta cheese is finely grated and combined with finely grated onion and garlic prior to being mixed with the other ingredients. The resultant mixture is refrigerated immediately at 36 to 46 degrees F.

### CROSS-REFERENCE TO RELATED APPLICATIONS

This application is a continuing application claiming the benefit of U.S. Provisional Application No. 63/063,253 filed 8 Aug. 2020.

### BACKGROUND

The present invention is directed to a food compound and method of preparing the same. In particular, the present invention is directed to making a Greek salad dressing variety which is prepared from a unique blend of natural and healthy ingredients and has a unique flavor.

As technological advances take place our habits and taste change in accordance therewith. In particular, as the body of research grows larger, the scientists learn more about the effects of various food items, consumed daily, on our health. For example, in relatively recent studies the scientists, particularly health professionals, learned the adverse effects of a fatty substance, known as “cholesterol”. One of the major sources of cholesterol is the yolk portion of an egg, a fairly common item of breakfast in our daily diet. It is now common knowledge that high amounts of cholesterol could lead to arteriosclerosis which causes heart-attack. As a result of this discovery, the Government has established recommended levels of cholesterol to prevent the occurrence of this deadly disease.

Another major medical discovery of this century has been the adverse effects of animal protein or fat on people's health. Animal meat, particularly beef, has been a major source of protein in the daily diet of the people in this century. The adverse effects of animal protein and fats have, however, led people to severely cut back on the consumption thereof and switch their diet to include non-animal protein and fat.

Many new scientific discoveries, including those noted above, have shifted the industry's attention to seek alternatives in making food items that provide the recommended daily level of nourishment without adversely affecting the health, while keeping in mind our insatiable desire for new and improved taste. In particular, the consumers have expressed preference to those food items that are less fattening, low in cholesterol, contain more natural and healthy ingredients. As a result, the industry responded by producing food items that were low in fat or contained fat substitutes, etc.

Although the industry has produced countless numbers of food items that are low in fat, low in calories, and apparently more healthy, it has been challenging to provide a food product which is low in fat, healthy, and yet satisfies consumers' constant urge for a new and better taste. This phenomenon is no more visible than in salad dressings. As the consumers switched their diets to more natural and healthy ingredients, such as vegetables and fruits, the food industry responded by providing numerous varieties of salad dressings. One merely need to visit a local grocery store to see many different varieties of salad dressings that adorn the shelves. However, many of these dressings either require the use of a large quantity to be palatable, or are not considered healthy in that they do contain egg yolks, etc.

Accordingly, there is a need in the industry for a salad dressing which is prepared from a unique blend of natural and healthy ingredients, and coats the salad with its unique flavor while not having to use an excessive amount as in most conventional dressings.

### Objects and Brief Summary of the Invention

The principal object of the present invention is to provide a food compound, and particularly a salad dressing, which overcomes the drawbacks associated with conventional dressings.

An object of the present invention is to provide a salad dressing which is prepared from a unique blend of natural and healthy ingredients.

Another object of the present invention is to provide a salad dressing which coats the salad with its unique flavor and does not require the use of an excessive amount.

An additional object of the present invention is to provide a salad dressing which does not use egg yolk.

Yet an additional object of the present invention is to provide a method of preparing a food compound, such as a salad dressing, which is prepared from a unique blend of natural and healthy ingredients, and which coats the salad with its unique flavor without having to use an excessive amount thereof.

In summary, the main object of the present invention is to provide a food compound in the form of a salad dressing, and a method of preparing the same, wherein the dressing is made from a unique blend of natural and healthy ingredients. The salad dressing made in accordance with the present invention has a unique flavor and does not require the use of a large amount for coating the salad.

### DETAILED DESCRIPTION

The present invention, while not limited to, contemplates preparing a unique salad dressing.

In carrying out the method of the invention, various ingredients are first selected and prepared in the quantities or proportions (by weight), shown below in Table 1.

TABLE 1 INGREDIENT RANGES PREFERRED RANGES A. Feta Cheese About 13.1% B. Onion about 10.7% C. Oil About 51.7% D. Vinegar About 8.6% E Sugar About 0.943% F. Brine from Feta Juice About 14.36% G. Garlic About 0.323% H. Black Pepper about 0.138% I. Parsley about 0.030% J. Oregano about 0.102% K. Basil about 0.023%.

TABLE 1 INGREDIENT PREFERRED AMOUNTS (For 5 Gallons of dressing)

A. Feta Cheese, six pounds (96 OZ) B. Onions, five pounds (80 OZ) C. Oil, 3 gallons (384 OZ) D. Vinegar, ½ gallon (64 OZ) E. Sugar, one cup (7 OZ) F. Brine from Feta Juice, three quarts (106.5 OZ) G. Garlic, ½ cup (2.4 OZ) H. Black Pepper, ¼ cup (1.03 OZ), I. Parsley ¼ cup (0.225 OZ) J. Oregano ¼ cup (0.762 OZ) K. Basil, ¼ cup (0.1775 OZ).

The following Table 2 lists different varieties for the ingredients that may preferably be used in carrying out the invention.

TABLE 2 INGREDIENT VARIETIES A. Feta Cheese (preferably Athena brand) B. white Onion C. Oil (preferably Divo brand oil) D. Vinegar (preferably Divo brand distilled white vinegar) E. Sugar F. Brine from Feta Juice (preferably Athena brand) G. Granulated Garlic H. Black Pepper I. Parsley J. Oregano K. Basil

Once the ingredients have been selected in the desired amounts, the following method of the invention is observed. When referring to mesh size the US Mesh size is the standard unit of measure or the number of openings in one square inch of a screen.

The selected feta cheese is crushed through a grater and finely grated (6-8 mesh), next the onion is crushed through a grater and finely grated (6-8 mesh), the Garlic is crushed through a grater and finely grated (30-34 mesh) and the crushed onion, feta, and garlic are combined together and stirred thoroughly until mixed evenly throughout the desired volume. Next the following ingredients are added to the feta, onion, garlic mix and the combination of ingredients is mixed until the blended mixture is equally consistent throughout the 5 gallon volume of ingredients:

Oil, Vinegar, sugar, brine from feta juice, black pepper, parsley, oregano, basil.

When mixing the ingredients, to avoid the feta and onion from being clumped up the oil ingredient may vary from the preferred amounts as desired for consistency.

The resultant mixture is then refrigerated immediately at 36.degree.-46.degree. The food compound, or the salad dressing, so prepared may then be removed from refrigeration for packaging or use.

As may be noted from above, the food compound, and particularly the salad dressing, of the present invention is prepared by using only the natural and healthy ingredients which, when processed in accordance with the method outlined above, produce a salad dressing that has a new and unique flavor. While this invention has been described as having preferred ranges, steps, materials, or designs, it is understood that it is capable of further modifications, uses and/or adaptations of the invention following in general the principle of the invention, and including such departures from the present disclosure, as those come within the known or customary practice in the art to which the invention pertains and as may be applied to the central features hereinbefore set forth, and fall within the scope of the invention.

I claim:

1. A recipe for a salad dressing, comprising ingredients combined in proportions substantially including:

| Ingredient | Proportion |
|---|---|
| Feta Cheese | (96 OZ) |
| Onions | (80 OZ) |
| Oil | (384 OZ) |
| Vinegar | (64 OZ) |
| Sugar | (7 OZ) |
| Brine from Feta Juice | (106.5 OZ) |
| Garlic | (2.4 OZ) |
| Black Pepper | (1.03 OZ) |
| Parsley | (.225 OZ) |
| Oregano | (.762 OZ) |
| Basil | (.1775 OZ). |

2. The recipe of claim 1 wherein the feta cheese is Athena Brand;

3. The recipe of claim 1 wherein the oil is Divo brand;

4. The recipe of claim 1 wherein the vinegar is divo brand distilled white vinegar;

5. The recipe of claim 1 wherein the Brine from feta juice is Athena brand;

6. The recipe of claim 1 wherein the garlic is granulated;

7. The recipe of claim 1 where the onion is granulated;

8. The recipe of claim 1 where the feta is granulated;

9. The recipe of claim 7 where the onion grate is between about 6 to about 8 mesh;

10. The recipe of claim 8 where the feta grate is between about 6 to about 8 mesh;

11. The recipe of claim 6 where the garlic grate is between about 30 to about 34 mesh;

12. A method of making a salad dressing comprising the steps of:
Finely grating feta cheese to about 6 to about 8 mesh consistency;
Finely grating onion to about 6 to about 8 mesh consistency;
Finely grating garlic to about 30 to about 34 mesh consistency;
Mixing said finely grated feta cheese, said finely grated onion, and said finely grated garlic thoroughly;
Combining said mixed finely grated feta cheese, onion and garlic with the following ingredients:
Oil
Vinegar
Sugar
Brine from Feta Juice
Black Pepper
Parsley
Oregano;
Refrigerating said combination to a temperature of about 36 to about 46 degrees Fahrenheit.

13. A method of making a salad dressing as in claim 12 wherein said feta, onion, garlic, oil, vinegar, sugar, brine, black pepper, parsley and oregano are combined in proportions substantially including:

| Ingredient | Proportion |
|---|---|
| Feta Cheese | (96 OZ) |
| Onions | (80 OZ) |
| Oil | (384 OZ) |
| Vinegar | (64 OZ) |
| Sugar | (7 OZ) |
| Brine from Feta Juice | (106.5 OZ) |
| Garlic | (2.4 OZ) |
| Black Pepper | (1.03 OZ) |
| Parsley | (.225 OZ) |
| Oregano | (.762 OZ) |
| Basil | (.1775 OZ). |

14. A recipe for a salad dressing, comprising ingredients combined in proportions substantially including:

| Ingredient | Proportion |
|---|---|
| Feta Cheese | about 13.1% |
| Onions | about 10.7% |
| Oil | about 51.7% |
| Vinegar | about 8.6% |
| Sugar | about .943% |
| Brine from | about 14.36% |
| Feta Juice | |
| Garlic | about .323% |
| Black Pepper | about .138% |
| Parsley | about .030% |
| Oregano | about .102% |
| Basil | about .023% |

15. The recipe of claim 14 wherein the garlic is granulated;

16. The recipe of claim 14 where the onion is granulated;

17. The recipe of claim 14 where the feta is granulated;

18. The recipe of claim 16 where the onion grate is between about 6 to about 8 mesh:

19. The recipe of claim 17 where the feta grate is between about 6 to about 8 mesh;

20. The recipe of claim 15 where the garlic grate is between about 30 to about 34 mesh;
